(19) United States
(12) Patent Application Publication
(10) Pub. No.: US 2023/0044033 A1
(43) Pub. Date: Feb. 9, 2023

(54) QUICK-RELEASE FASTENER STRUCTURE

(71) Applicant: FIVETECH TECHNOLOGY INC., New Taipei City (TW)

(72) Inventors: TING-JUI WANG, New Taipei City (TW); MING-YUAN CHEN, New Taipei City (TW); HSIN-LIN HUANG, New Taipei City (TW)

(21) Appl. No.: 17/968,820

(22) Filed: Oct. 19, 2022

Related U.S. Application Data
(62) Division of application No. 16/907,326, filed on Jun. 22, 2020.

(51) Int. Cl. F16B 5/02; F16B 2/18

(52) U.S. Cl. CPC F16B 5/0208; F16B 5/0266; F16B 2/185

(57) ABSTRACT

A quick-release fastener structure includes a body portion and an engaging portion. The body portion is fitted to a first object. The engaging portion is movably fitted to the body portion. The engaging portion has a head portion, a bar portion with an end connected to the head portion, and an engaging-connecting portion disposed at another end of the bar portion. The engaging-connecting portion is insertedly engaged with or separated from a second object. Therefore, the quick-release fastener structure operates by fitting the body portion to the first object and allowing the engaging portion to be engagedly connected to the second object or removed from the second object, such that the at least two objects are coupled together and separated repeatedly and quickly.

### CROSS-REFERENCE TO RELATED APPLICATION

This application is a divisional patent application of U.S. application Ser. No. 16/907,326 filed on Jun. 22, 2020, the entire contents of which are hereby incorporated by reference for which priority is claimed under 35 U.S.C. § 121.

### BACKGROUND OF THE INVENTION

### 1. Field of the Invention

The present disclosure relates to a quick-release fastener structure and, more particularly, to a quick-release fastener structure for coupling together and separating at least two objects repeatedly and quickly.

### 2. Description of the Related Art

Conventionally, at least two objects are coupled together with screws.

Although the foregoing conventional way of fixation can fix and couple together at least two objects in an inseparable manner, it not only causes difficulty in assembly but also makes at least one object difficult to unfasten because the screws fix and couple together the at least two objects.

### BRIEF SUMMARY OF THE INVENTION

In at least one embodiment of the present disclosure, a quick-release fastener structure of the present disclosure comprises a body portion fitted to a first object and an engaging portion engagedly connected to a second object or removed from the second object. Therefore, the quick-release fastener structure is capable of coupling together and separating at least two objects repeatedly and quickly.

The present disclosure provides a quick-release fastener structure, comprising a body portion and an engaging portion. The body portion is fitted to a to first object. The engaging portion is movably fitted to the body portion and has a head portion, a bar portion with an end connected to the head portion, and an engaging-connecting portion disposed at the bar portion. The engaging-connecting portion insertedly engages with or separates from the second object.

The quick-release fastener structure is effective in fitting the body portion to the first object and allowing the engaging portion to be engagedly connected to the second object or removed from the second object. Therefore, the quick-release fastener structure is capable of coupling together and separating at least two objects repeatedly and quickly.

Optionally, the body portion has a fitting-connecting portion, and the fitting-connecting portion is fitted to the first object.

Optionally, a stopping-blocking portion is disposed inside or outside the body portion, and the engaging portion has a blocking-pressing portion restrictively blocked and thus stopped by the stopping-blocking portion.

Optionally, the head portion and the bar portion are fitted together by a fixing portion.

Optionally, the engaging-connecting portion has a guiding portion which corresponds in position to a corresponding guiding portion of a second object to allow the engaging-connecting portion to guide and insertedly engage with the second object.

Optionally, the guiding portion or the corresponding guiding portion is an inclined surface portion, arced surface portion, stepwise surface portion, curved surface portion, elevated surface portion, depressed surface portion or flat surface portion.

Optionally, the quick-release fastener structure further comprises a resilient component with an end pressing against the engaging portion and another end pressing against the body portion.

Optionally, the resilient component is a spring, leaf spring or resilient cylinder.

Optionally, the quick-release fastener structure further comprises a resilient component being a torsion spring and having an end fitted to the engaging portion and another end fitted to the body portion to cause automatic reciprocating motion of the head portion or the engaging-connecting portion.

Optionally, the head portion has a restricting portion, and the body portion has a limiting portion for limiting the restricting portion.

Optionally, the head portion is limited by the body portion when the restricting portion is at the limiting portion, and the head portion rotates within the body portion when the restricting portion separates from the limiting portion.

Optionally, the head portion forms a leverage structure on the body portion, such that the restricting portion separates from the limiting portion when the head portion is pressed.

Optionally, the head portion has an operation portion pressable to allow the head portion to turn about a fixing portion and thus press against the body portion, such that the restricting portion separates from the limiting portion.

Optionally, the body portion has a through hole, and the bar portion penetrates the through hole in order to be fitted to the head portion, or the bar portion penetrates the through hole in order to be integrally formed with the head portion.

Optionally, the body portion has a first stopping-blocking portion or a second stopping-blocking portion, such that the head portion rotates relative to the first stopping-blocking portion or the second stopping-blocking portion, and the head portion is stopped and thus blocked by the first stopping-blocking portion or the second stopping-blocking portion.

Optionally, the body portion has a limiting portion, and the head portion has a restricting portion, wherein the limiting portion of the body portion limits the restricting portion of the head portion when the head portion rotates to the limiting portion.

Optionally, the quick-release fastener structure further comprises a resilient component with an end pressing against the body portion and another end pressing against the engaging portion, such that the restricting portion is insertedly engaged with the limiting portion under a downward-pulling resilient force of the resilient component when the restricting portion of the head portion reaches the limiting portion.

Optionally, the body portion has a rotation portion, and the head portion rotates within the rotation portion.

Optionally, the body portion has a limiting portion or another limiting portion, and the head portion has a restricting portion, wherein the limiting portion or the another limiting portion limits the restricting portion of the head portion when the head portion rotates to the limiting portion or the another limiting portion.

Optionally, the body portion has a stopping-blocking portion, and the bar portion has a blocking-pressing portion restrictively blocked and thus stopped by the stopping-blocking portion.

Optionally, the head portion has an operation portion pressable to allow the head portion to turn about a bar portion and thus press against the body portion, such that the restricting portion separates from the limiting portion.

Optionally, the stopping-blocking portion or the blocking-pressing portion is an elevated portion, depressed portion, stepwise portion, recess portion, hole portion, engaging portion, arced surface portion, curved surface portion, inclined surface portion or flat surface portion.

Optionally, the restricting portion or the limiting portion is a depressed portion, elevated portion, stepwise portion, flat surface portion, inclined surface portion, curved surface portion, arced surface portion or limiting space.

Optionally, the head portion has an engaging-connecting portion which insertedly engages with, interferes with, lies on or separates from a second object.

Optionally, the body portion has an engaging-connecting portion which insertedly engages with, interferes with, lies on or separates from a second object.

Optionally, the engaging-connecting portion is a depressed portion, elevated portion, stepwise portion, flat surface portion, inclined surface portion, curved surface portion, arced surface portion or engaging-connecting space.

Optionally, the bar portion has a blocking-pressing portion and a pressing-blocking portion, and the blocking-pressing portion rotatably coordinates with the body portion.

Optionally, the bar portion has a blocking-pressing portion and a pressing-blocking portion, and the pressing-blocking portion rotatably coordinates with the head portion.

Optionally, the bar portion rotatably coordinates with the head portion or the body portion.

Optionally, the restricting portion or the limiting portion is a resilient element with resilience or a resilient arm with resilience.

Optionally, the restricting portion or the limiting portion is vertical, inside the head portion, outside the head portion, outside the body portion or inside the body portion.

Optionally, the head portion or the body portion has at least one retraction space which retracts to be positioned in place or retracts to be temporarily positioned in place when the head portion and the body portion engagingly connect with each other, temporarily engagingly connect with each other, interfere with each other or temporarily interfere with each other.

Optionally, the retraction space is closed-style or open-style.

Optionally, the bar portion or the head portion has a guide surface, such that the bar portion easily guides and insertedly engages with the head portion, and the guide surface is an inclined surface, arced surface, curved surface, stepwise surface, depressed surface, elevated surface, vertical surface or flat surface.

Optionally, the head portion is manufactured by plastic in-mold injection.

Optionally, the head portion has a rotation-proof structure, and the bar portion has a corresponding rotation-proof structure for preventing rotation of the head portion.

Optionally, the quick-release fastener structure further comprises a resilient component being a torsion spring and having an end fitted to the engaging portion and another end fitted to the body portion, allowing automatic reciprocating motion of the head portion or the engaging-connecting portion, wherein the engaging-connecting portion of the engaging portion has a guiding portion corresponding in position to a corresponding guiding portion of a second object, such that the engaging-connecting portion guidingly rotates to an insertedly engageable position and then resiliently insertedly engages with the second object.

Optionally, the quick-release fastener structure further comprises a resilient component being a torsion spring and having an end fitted to the engaging portion and another end fitted to the body portion to cause automatic reciprocating motion of the head portion or the engaging-connecting portion, wherein the engaging-connecting portion of the engaging portion has a guiding portion, such that the engaging-connecting portion guidingly insertedly engages with the second object.

Optionally, the engaging-connecting portion of the engaging portion has a guiding portion whereby the engaging-connecting portion is guidedly insertedly engaged with the second object, and the guiding portion is an inclined surface portion, arced surface portion, stepwise surface portion, curved surface portion, elevated surface portion, depressed surface portion or flat surface portion.

Optionally, the width of the bar portion is greater than the width of the head portion. The hardness of the bar portion is greater than the hardness of the head portion. The bar portion is inserted into the head portion by hard interference, such that the bar portion is fitted to the head portion.

### BRIEF DESCRIPTION OF THE DRAWINGS

Accompanying drawings required for description of embodiments of the present disclosure are briefly described below, such that the embodiments of the present disclosure or the prior art can be clearly described. Obviously, the accompanying drawings described below only serve to illustrate some embodiments of the present disclosure; hence, persons skilled in the art can obtain additional accompanying drawings in accordance with the foregoing accompanying drawings without making any creative efforts.

FIG. 1 is a schematic perspective view of the first embodiment of the present disclosure.

FIG. 2 is a schematic view of the state of use of the first embodiment of the present disclosure.

FIG. 3 is a schematic bottom view of the first embodiment of the present disclosure.

FIG. 4 is a schematic view 1 of the state of use of the second embodiment of the present disclosure.

FIG. 5 is a schematic view 2 of the state of use of the second embodiment of the present disclosure.

FIG. 6 is a schematic view 1 of the state of use of the third embodiment of the present disclosure.

FIG. 7 is a schematic view 2 of the state of use of the third embodiment of the present disclosure.

FIG. 8 is a schematic perspective view of a body portion in the third embodiment of the present disclosure.

FIG. 9 is a schematic perspective view of the body portion in the fourth embodiment of the present disclosure.

FIG. 10 is a schematic cross-sectional view of the fourth embodiment of the present disclosure.

FIG. 11 is a schematic cross-sectional view of the fifth embodiment of the present disclosure.

FIG. 12 is a schematic cross-sectional view of the sixth embodiment of the present disclosure.

FIG. 13 is a schematic view 1 of the state of use of the seventh embodiment of the present disclosure.

FIG. 14 is a schematic view 2 of the state of use of the seventh embodiment of the present disclosure.

FIG. 15 is a schematic lateral view of the eighth embodiment of the present disclosure.

FIG. 16 is a schematic cross-sectional view of the ninth embodiment of the present disclosure.

FIG. 17 is a schematic cross-sectional view of the tenth embodiment of the present disclosure.

FIG. 18 is a schematic cross-sectional view of the eleventh embodiment of the present disclosure.

FIG. 19 is a schematic view 1 of different forms of an engaging-connecting portion of the present disclosure.

FIG. 20 is a schematic view 2 of different forms of the engaging-connecting portion of the present disclosure.

FIG. 21 is a schematic view of the state of use of the twelfth embodiment of the present disclosure.

FIG. 22 is a schematic view 1 of the state of use of the thirteenth embodiment of the present disclosure.

FIG. 23 is a schematic view 2 of the state of use of the thirteenth embodiment of the present disclosure.

FIG. 24 is a schematic cross-sectional view of the fourteenth embodiment of the present disclosure.

FIG. 25 is a schematic view of the fifteenth embodiment of the present disclosure.

FIG. 26 is a schematic view of the sixteenth embodiment of the present disclosure.

FIG. 27 is a schematic view of the seventeenth embodiment of the present disclosure.

FIG. 28 is a schematic view of the eighteenth embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

A quick-release fastener structure in embodiments of the present disclosure is described below with reference to accompanying drawings.

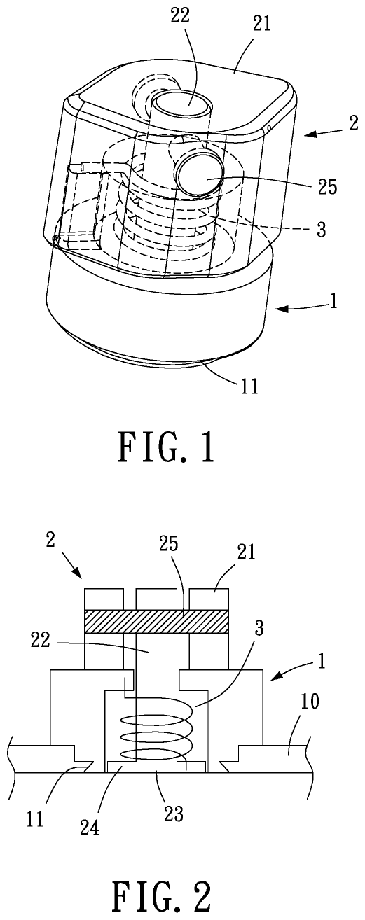

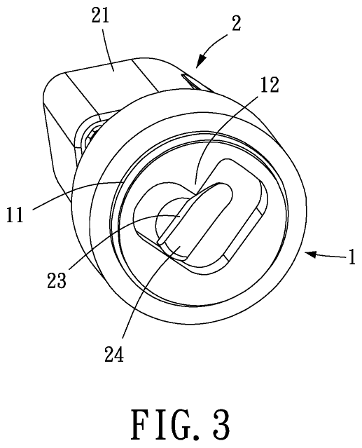

Referring to FIG. 1 through FIG. 3, as shown in the diagrams, the present disclosure provides a quick-release fastener structure. The quick-release fastener structure comprises a body portion 1 and an engaging portion 2.

The body portion 1 is fitted to a first object 10.

The engaging portion 2 is movably fitted to the body portion 1. The engaging portion 2 has a head portion 21, a bar portion 22 with an end connected to the head portion 21, and an engaging-connecting portion 23 disposed at another end of the bar portion 22. The engaging-connecting portion 23 is insertedly engaged with or separated from a second object 20.

To use the quick-release fastener structure, a user fits the body portion 1 to the first object 10 and rotates the head portion 21 to cause the head portion 21 to drive the bar portion 22 and the engaging-connecting portion 23 rotating simultaneously, such that the engaging-connecting portion 23 is insertedly engaged with the second object 20, so as to couple the first object 10 and the second object 20 together. Furthermore, the user rotates the head portion 21 reversely to cause the head portion 21 to drive the bar portion 22 and the engaging-connecting portion 23 rotating simultaneously, such that the engaging-connecting portion 23 is removed from the second object 20, so as to separate the first object 10 and the second object 20. Therefore, the quick-release fastener structure is capable of coupling together and separating at least two objects repeatedly and quickly.

In a preferred embodiment of the present disclosure, the body portion 1 has a fitting-connecting portion 11. The fitting-connecting portion 11 is fitted to the first object 10. Therefore, the body portion 1 is firmly fitted to the first object 10 through the fitting-connecting portion 11 to facilitate operation of the engaging portion 2.

In a preferred embodiment of the present disclosure, a stopping-blocking portion 12 is disposed inside or outside the body portion 1, the bar portion 22 of the engaging portion 2 has a blocking-pressing portion 24 restrictively blocked and thus stopped by the stopping-blocking portion 12. The stopping-blocking portion 12 and the blocking-pressing portion 24 are elevated portions, depressed portions, stepwise portions, recess portions, hole portions, engaging portions, arced surface portions, curved surface portions, inclined surface portions or flat surface portions. Therefore, with the head portion 21 being rotated and the blocking-pressing portion 24 being restrictively blocked and thus stopped by the stopping-blocking portion 12, the head portion 21 drives the bar portion 22 and the engaging-connecting portion 23 rotating by 90 degrees only, such that the engaging-connecting portion 23 is precisely insertedly engaged with the second object 20.

In a preferred embodiment of the present disclosure, the head portion 21 and the bar portion 22 are fitted together by a fixing portion 25. Therefore, the rotation of the head portion 21 causes the bar portion 22 and the engaging-connecting portion 23 to rotate simultaneously.

In a preferred embodiment of the present disclosure, the quick-release fastener structure further comprises a resilient component 3. The resilient component 3 has an end pressing against the engaging portion 2 and another end pressing against the body portion 1. The resilient component 3 is a torsion spring, spring, leaf spring or resilient cylinder. In this embodiment, the resilient component 3 is a torsion spring, such that the resilient component 3 has an end fitted to the engaging portion 2 and another end fitted to the body portion 1, allowing automatic reciprocating motion of the head portion 21 and the engaging-connecting portion 23. Therefore, the rotation of the head portion 21 causes the head portion 21 to drive the bar portion 22 and the engaging-connecting portion 23 rotating and causes the resilient component 3 to undergo torsion-dependent contraction, such that the engaging-connecting portion 23 and the second object 20 are not engagedly connected. The release of the head portion 21 causes the bar portion 22 and the engaging-connecting portion 23 to rotate reversely under a torsional resilient force of the resilient component 3, such that the engaging-connecting portion 23 automatically insertedly engages with the second object 20. Therefore, the quick-release fastener structure is capable of coupling the first object 10 and the second object 20 together. To separate the first object 10 and the second object 20, the user rotates the head portion 21 again to cause the head portion 21 to drive the rotation of the bar portion 22 and the engaging-connecting portion 23 and cause the resilient component 3 to undergo torsion-dependent contraction, such that the engaging-connecting portion 23 is removed from the second object 20, thereby separating the first object 10 and the second object 20. After that, the user releases the head portion 21, such that the engaging-connecting portion 23 automatically returns to its initial position for later use. Therefore, the quick-release fastener structure is capable of coupling together and separating at least two objects repeatedly and quickly.

In a preferred embodiment of the present disclosure, the engaging-connecting portion 23 is an external engaging element, internal engaging element, cylinder element or thread element.

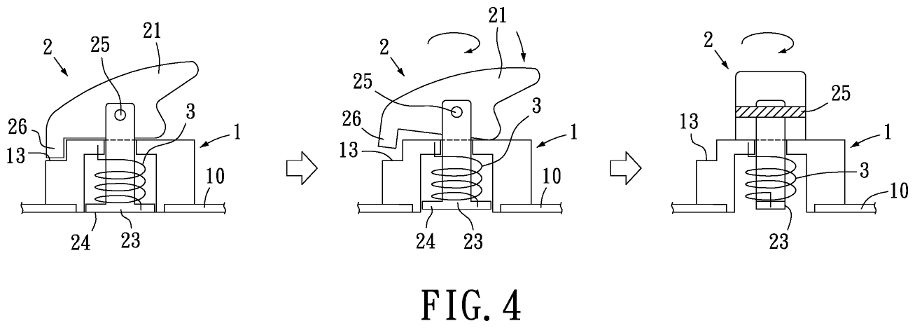

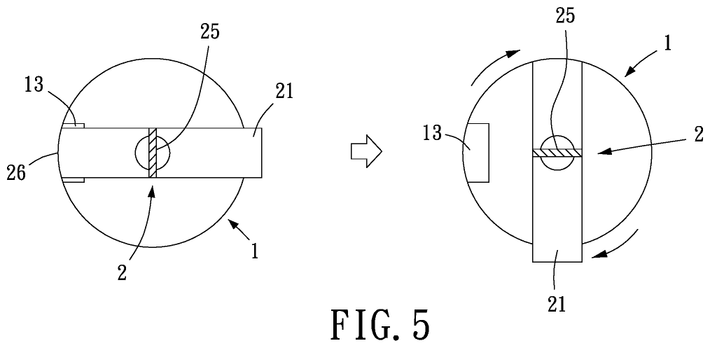

Referring to FIG. 4 and FIG. 5, as shown in the diagrams, in a preferred embodiment of the present disclosure, the head portion 21 and the bar portion 22 are fixed together by the fixing portion 25, such that the head portion 21 forms a leverage structure on the body portion 1. The head portion 21 has a restricting portion 26. The body portion 1 has a limiting portion 13 for limiting the restricting portion 26. When the restricting portion 26 is at the limiting portion 13, the head portion 21 is limited by the body portion 1. When the restricting portion 26 separates from the limiting portion 13, the head portion 21 rotates within the body portion 1.

Therefore, the user may manipulate the head portion 21 by pressing it to not only separate the restricting portion 26 from the limiting portion 13 but also drive the engaging portion 2 rotating under a torsional resilient force of the resilient component 3, such that the engaging-connecting portion 23 is insertedly engaged with the second object 20 or removed from the second object 20, so as to separate the first object 10 and the second object 20. Therefore, the quick-release fastener structure is capable of coupling together and separating at least two objects repeatedly and quickly.

The restricting portion 26 or the limiting portion 13 is a depressed portion, elevated portion, stepwise portion, flat surface portion, inclined surface portion, curved surface portion, arced surface portion or limiting space. Therefore, the present disclosure meets requirements for practical application.

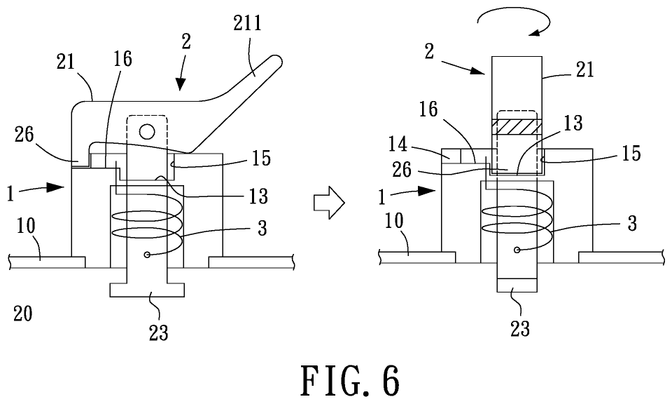

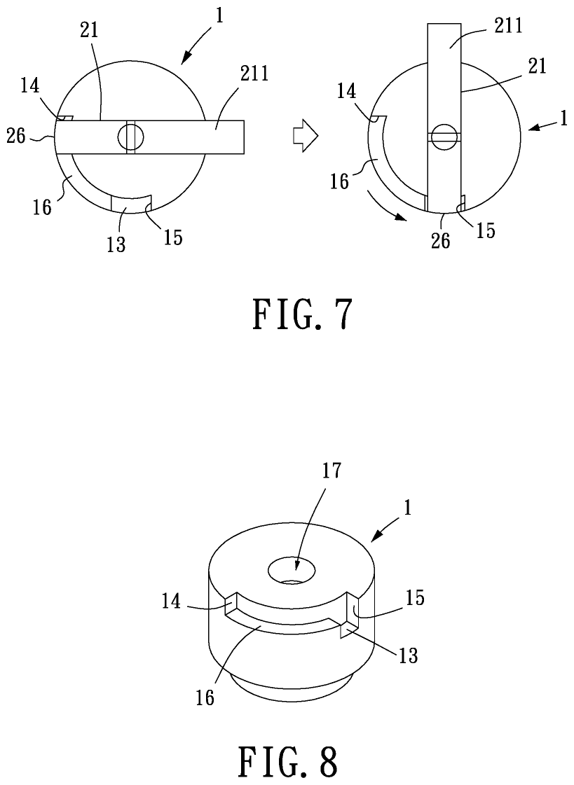

Referring to FIG. 6 through FIG. 8, as shown in the diagrams, in a preferred embodiment of the present disclosure, the head portion 21 has an operation portion 211 pressable to allow the head portion 21 to turn about the fixing portion 25 and thus press against the body portion 1, such that the restricting portion 26 separates from the limiting portion 13. After that, the head portion 21 drives the engaging portion 2 rotating under a torsional resilient force of the resilient component 3 and thereby causes the engaging-connecting portion 23 to be insertedly engaged with the second object 20 or removed from the second object 20 to separate the first object 10 and the second object 20. Therefore, the quick-release fastener structure is capable of coupling together and separating at least two objects repeatedly and quickly.

In a preferred embodiment of the present disclosure, the body portion 1 has a first stopping-blocking portion 14, a second stopping-blocking portion 15, and a rotation portion 16. The rotation portion 16 is disposed between the first stopping-blocking portion 14 and the second stopping-blocking portion 15. The head portion 21 rotates within the rotation portion 16 between the first stopping-blocking portion 14 and the second stopping-blocking portion 15. The head portion 21 is stopped and thus blocked by the first stopping-blocking portion 14 or the second stopping-blocking portion 15. Therefore, the present disclosure meets requirements for practical application.

In a preferred embodiment of the present disclosure, the resilient component 3 has an end pressing against the body portion 1 and another end pressing against the bar portion 22 of the engaging portion 2, such that the restricting portion 26 of the head portion 21 is insertedly engaged with the limiting portion 13 under a downward-pulling resilient force of the resilient component 3 when the restricting portion 26 of the head portion 21 reaches the limiting portion 13. Therefore, the present disclosure meets requirements for practical application.

In a preferred embodiment of the present disclosure, the body portion 1 has a through hole 17. The bar portion 22 of the engaging portion 2 penetrates the through hole 17 in order to be fitted to the head portion 21. Alternatively, the bar portion 22 of the engaging portion 2 penetrates the through hole 17 in order to be integrally formed with the head portion 21 (shown in FIG. 8). Therefore, the present disclosure meets requirements for practical application.

When the bar portion 22 is integrally formed with the head portion 21, the operation portion 211 is pressable to allow the head portion 21 to turn about the bar portion 22 and thus press against the body portion 1, such that the restricting portion 26 separates from the limiting portion 13 (not shown). Therefore, the present disclosure meets requirements for practical application.

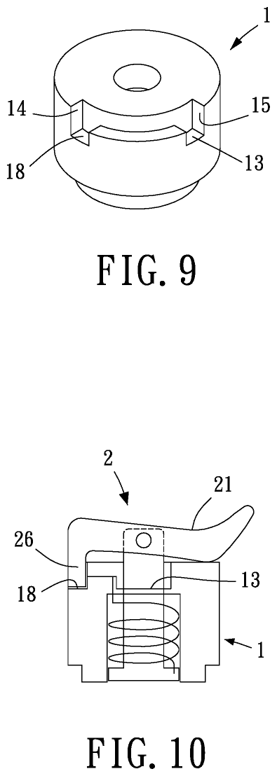

Referring to FIG. 9 and FIG. 10, as shown in the diagrams, in a preferred embodiment of the present disclosure, the body portion 1 has a limiting portion 13 and another limiting portion 18. When the head portion 21 rotates to the limiting portion 13 or the another limiting portion 18, the limiting portion 13 or the another limiting portion 18 limits the restricting portion 26 of the head portion 21. Therefore, the head portion 21 can be manipulated in such a manner that the restricting portion 26 not only separates from the limiting portion 13 but also presses against the body portion 1 and the engaging portion 2 under the resilient force of the resilient component 3; hence, the restricting portion 26 rotates to the another limiting portion 18 and resiliently insertedly engages therewith. Therefore, the present disclosure meets requirements for practical application.

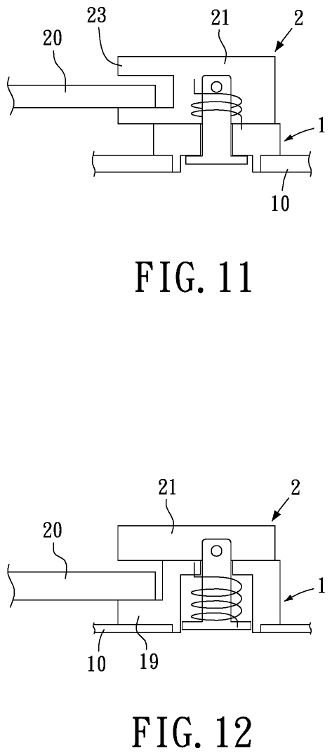

Referring to FIG. 11, as shown in the diagram, in a preferred embodiment of the present disclosure, the body portion 1 is fitted to the first object 10, and the head portion 21 of the engaging portion 2 has an engaging-connecting portion 23 which insertedly engages with (interferes with, lies on or separates from) the second object 20. The engaging-connecting portion 23 is a depressed portion, elevated portion, stepwise portion, flat surface portion, inclined surface portion, curved surface portion or arced surface portion. Therefore, the present disclosure meets requirements for practical application.

Referring to FIG. 12, as shown in the diagram, in a preferred embodiment of the present disclosure, the body portion 1 is fitted to the first object 10, and the body portion 1 has an engaging-connecting portion 19. The engaging-connecting portion 19 operates in conjunction with the head portion 21 of the engaging portion 2 and thus insertedly engages with (interferes with, lies on or separates from) the second object 20. The engaging-connecting portion 19 is a depressed portion, elevated portion, stepwise portion, flat surface portion, inclined surface portion, curved surface portion or arced surface portion. Therefore, the present disclosure meets requirements for practical application.

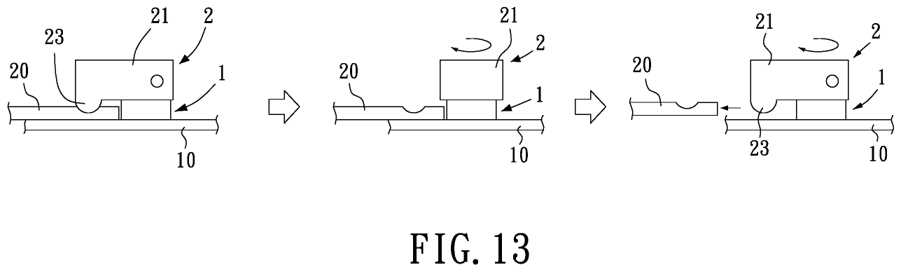

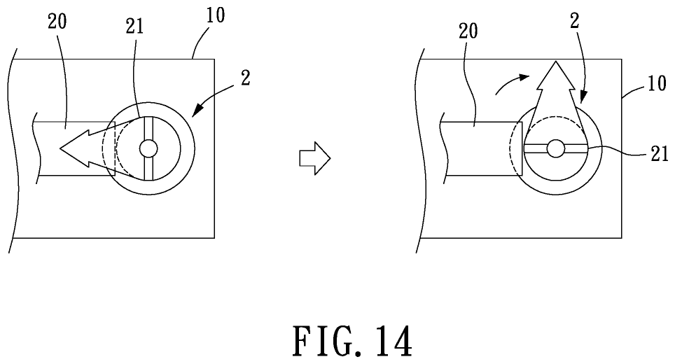

Referring to FIG. 13 and FIG. 14, as shown in the diagrams, in a preferred embodiment of the present disclosure, the engaging-connecting portion 23 fits the body portion 1 to the first object 10, and the head portion 21 of the engaging portion 2 is rotated. Thus, the engaging-connecting portion 23 insertedly engages with the second object 20 or rotates the head portion 21 of the engaging portion 2 when the engaging-connecting portion 23 is in a closed state. Alternatively, the engaging-connecting portion 23 is in an open state to separate the second object 20 from the first object 10. Therefore, the quick-release fastener structure is capable of coupling together and separating at least two objects repeatedly and quickly.

Alternatively, the engaging-connecting portion 23 (or engaging-connecting portion 19) is an engaging-connecting space whereby separation of the first object 10 and the second object 20 is achieved. Therefore, the quick-release fastener structure is capable of coupling together and separating at least two objects repeatedly and quickly.

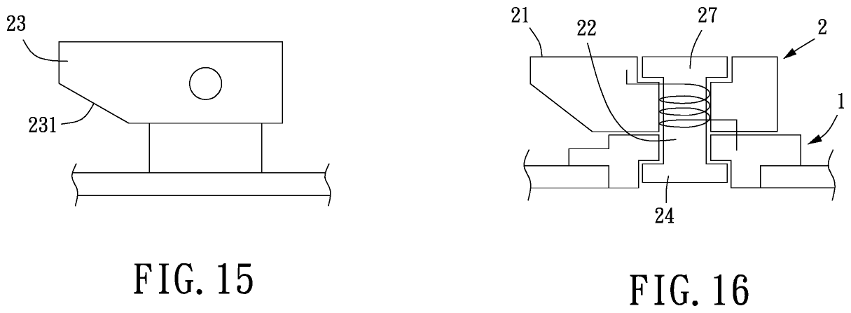

Referring to FIG. 15, as shown in the diagram, in a preferred embodiment of the present disclosure, the engaging-connecting portion 23 has a guiding portion 231. The guiding portion 231 corresponds in position to a corresponding guiding portion (not shown) of the second object, such that the engaging-connecting portion 23 can easily guide and insertedly engage with the second object. The guiding portion 231 and the corresponding guiding portion are inclined surface portions, arced surface portions, stepwise surface portions, curved surface portions, elevated surface portions, depressed surface portions or flat surface portions. Therefore, the present disclosure meets requirements for practical application.

Referring to FIG. 16, as shown in the diagram, in a preferred embodiment of the present disclosure, the bar portion 22 of the engaging portion 2 has the blocking-pressing portion 24 and a pressing-blocking portion 27. The blocking-pressing portion 24 and the body portion 1 can rotate in coordination with each other. The pressing-blocking portion 27 and the head portion 21 can rotate in coordination with each other. Thus, the bar portion 22 rotatably coordinates with the head portion 21 and the body portion 1. Therefore, the present disclosure meets requirements for practical application.

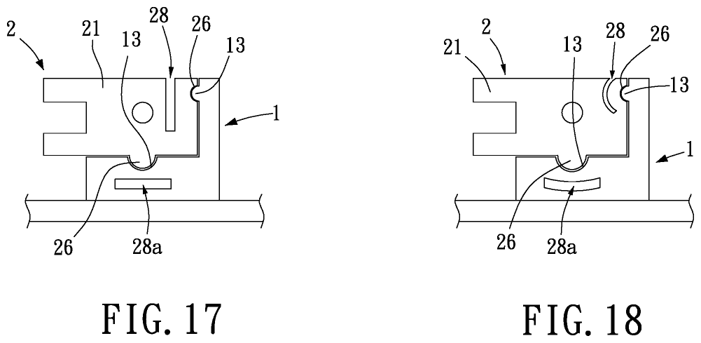

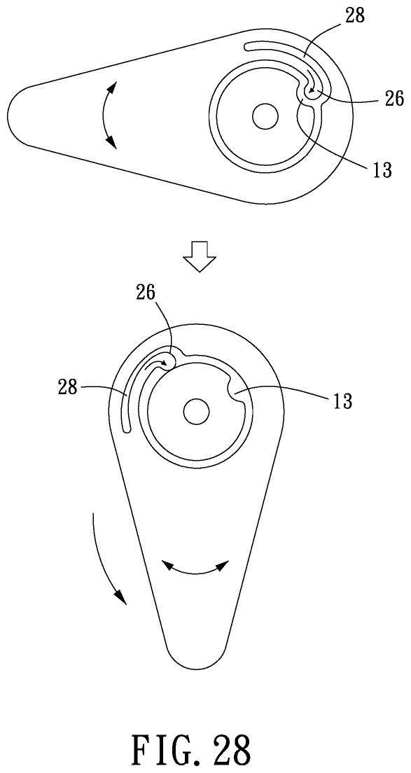

Referring to FIG. 17, FIG. 18, and FIG. 28, as shown in the diagrams, in a preferred embodiment of the present disclosure, the restricting portion 26 and the limiting portion 13 are resilient elements with resilience or resilient arms with resilience. The engaging portion 2 has retraction spaces 28, 28a positioned proximate to the restricting portion 26 and the limiting portion 13, respectively; hence, the retraction spaces 28, 28a retract to be positioned in place or retract to be temporarily positioned in place when the head portion 21 and the body portion 1 engagedly connect (temporarily engagedly connect, interfere or temporarily interfere) with each other. Therefore, the present disclosure meets requirements for practical application.

In a preferred embodiment of the present disclosure, the restricting portion 26 and the limiting portion 13 are vertical, inside the head portion 21, outside the head portion 21, outside the body portion 1 or inside the body portion 1. Therefore, the present disclosure meets requirements for practical application.

In a preferred embodiment of the present disclosure, the retraction spaces 28, 28a are closed-style, open-style, or a combination of closed-style and open-style. In a preferred embodiment of the present disclosure, the retraction spaces 28, 28a are preferably a combination of closed-style and open-style. Therefore, the present disclosure meets requirements for practical application.

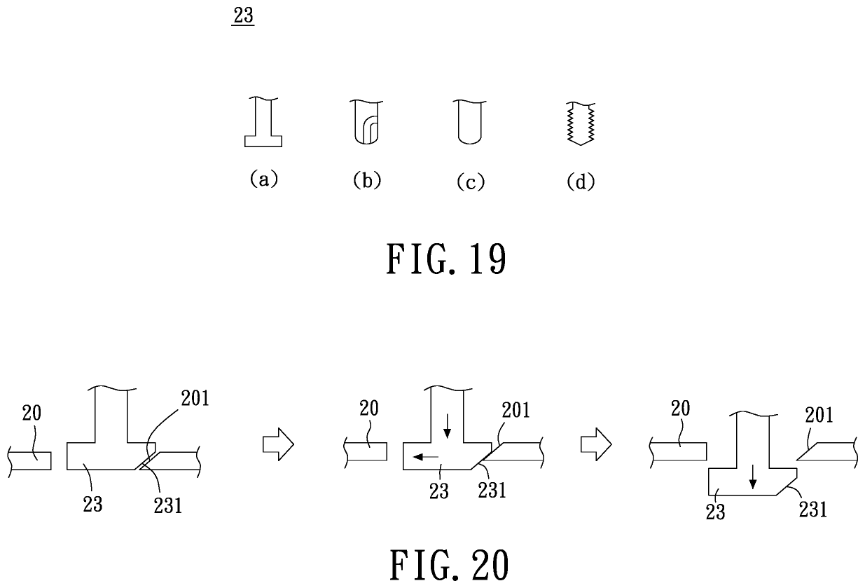

Referring to FIG. 19, as shown in the diagram, in a preferred embodiment of the present disclosure, the engaging-connecting portion 23 is an external engaging element (for example, part a of FIG. 19), internal engaging element (for example, part b of FIG. 19), cylinder element (for example, part c of FIG. 19) or thread element (for example, part d of FIG. 19).

Referring to FIG. 20, as shown in the diagram, in a preferred embodiment of the present disclosure, the engaging-connecting portion 23 has the guide surface 231. The guide surface 231 corresponds in position to a corresponding guiding portion 201 of the second object 20, such that the engaging-connecting portion 23 easily guides and insertedly engages with the second object 20. The guide surface 231 and the corresponding guiding portion 201 are inclined surfaces, arced surfaces, stepwise surfaces, curved surfaces, elevated surfaces, depressed surfaces or flat surfaces. Therefore, the present disclosure meets requirements for practical application.

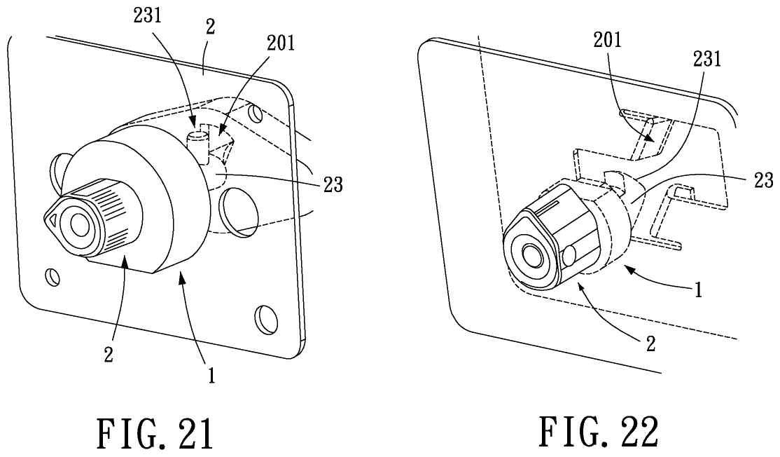

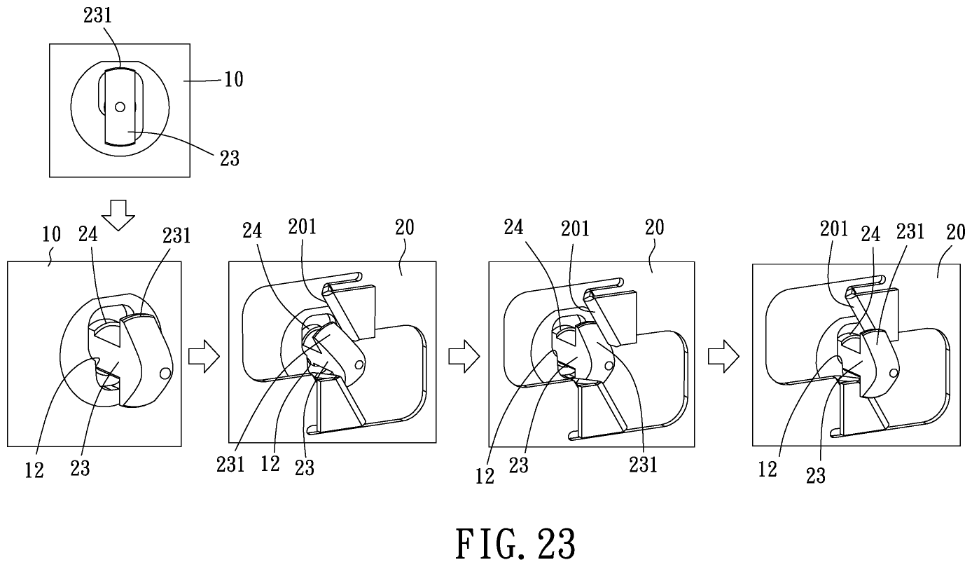

Referring to FIG. 21 through FIG. 23, as shown in the diagrams, in a preferred embodiment of the present disclosure, the engaging-connecting portion 23 of the engaging portion 2 has the guiding portion 231. The guiding portion 231 corresponds in position to the corresponding guiding portion 201 of the second object 20. The engaging-connecting portion 23 guidingly rotates to an insertedly engageable position and then resiliently insertedly engages with the second object 20, such that the engaging-connecting portion 23 easily guides and insertedly engages with the second object 20.

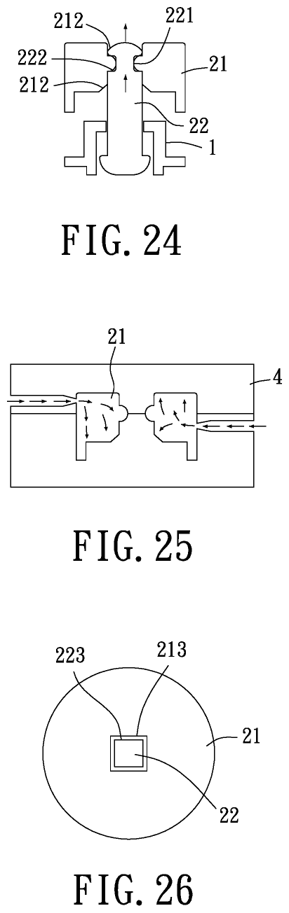

Referring to FIG. 24, as shown in the diagram, an end of the bar portion 22 has a snap-engaging portion 221. The snap-engaging portion 221 is snap-engaged with and fitted to the head portion 21. Alternatively, the snap-engaging portion 221 is snap-engaged with and fitted to the head portion 21 made of a resilient plastic. The snap-engaging portion 221 or the head portion 21 has guide surfaces 222, 212, such that the snap-engaging portion 221 easily guides and insertedly engages with the head portion 21. The guide surfaces 222, 212 are inclined surfaces, arced surfaces, curved surfaces, stepwise surfaces, depressed surfaces, elevated surfaces, vertical surfaces or flat surfaces.

Referring to FIG. 25, as shown in the diagram, the head portion 21 is manufactured with a mold 4 by plastic in-mold injection.

Referring to FIG. 26, as shown in the diagram, the head portion 21 has a rotation-proof structure 213, and the bar portion 22 (or the engaging-connecting portion) has a corresponding rotation-proof structure 223 for preventing rotation of the head portion 21.

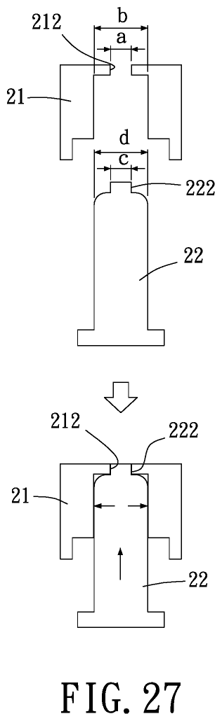

Referring to FIG. 27, width d of the bar portion 22 is greater than width b of the head portion 21, and the width of the guide surface 212 of the head portion 21 is greater than width c of the guide surface 222 of the bar portion 22. The hardness of the bar portion 22 is greater than the hardness of the head portion 21. The bar portion 22 is inserted into the head portion 21 by hard interference, such that the bar portion 22 is fitted to the head portion 21.

In short, a quick-release fastener structure provided in the embodiments of the present disclosure comprises a body portion fitted to a first object and an engaging portion engagedly connected to a second object or removable from the second object and thus can couple together and separate at least two objects repeatedly and quickly.

The embodiments of the present disclosure described above only serve an illustrative purpose but are not restrictive of the claims of the present disclosure.

While the present disclosure has been described by means of specific embodiments, numerous modifications and variations could be made thereto by those skilled in the art without departing from the scope and spirit of the present disclosure set forth in the claims.

What is claimed is:

1. A quick-release fastener structure, comprising:
a body portion fitted to a first object; and
an engaging portion movably fitted to the body portion and having a head portion and a bar portion with an end connected to the head portion.

2. The quick-release fastener structure of claim 1, wherein the body portion has a fitting-connecting portion, and the fitting-connecting portion is fitted to the first object.

3. The quick-release fastener structure of claim 1, wherein the head portion and the bar portion are fitted together by a fixing portion.

4. The quick-release fastener structure of claim 1, wherein an engaging-connecting portion of the engaging portion has a guiding portion which corresponds in position to a corresponding guiding portion of a second object to allow the engaging-connecting portion to guide and insertedly engage with the second object, wherein the guiding portion or the corresponding guiding portion is an inclined surface portion, arced surface portion, stepwise surface portion, curved surface portion, elevated surface portion, depressed surface portion or flat surface portion.

5. The quick-release fastener structure of claim 1, further comprising a resilient component being a torsion spring and having an end fitted to the engaging portion and another end fitted to the body portion to cause automatic reciprocating motion of the head portion or the engaging-connecting portion.

6. The quick-release fastener structure of claim 1, wherein the head portion or the body portion has an engaging-connecting portion which insertedly engages with, interferes with, lies on or separates from a second object, and the engaging-connecting portion is a depressed portion, elevated portion, stepwise portion, flat surface portion, inclined surface portion, curved surface portion, arced surface portion or engaging-connecting space.

7. The quick-release fastener structure of claim 1, wherein the bar portion has a blocking-pressing portion and a pressing-blocking portion, and the blocking-pressing portion rotatably coordinates with the body portion or the head portion.

8. The quick-release fastener structure of claim 1, further comprising a resilient component being a torsion spring and having an end fitted to the engaging portion and another end fitted to the body portion, allowing automatic reciprocating motion of the head portion or the engaging-connecting portion, wherein the engaging-connecting portion of the engaging portion has a guiding portion corresponding in position to a corresponding guiding portion of a second object, such that the engaging-connecting portion guidingly rotates to an insertedly engageable position and then resiliently insertedly engages with the second object.

9. The quick-release fastener structure of claim 1, further comprising a resilient component being a torsion spring and having an end fitted to the engaging portion and another end fitted to the body portion to cause automatic reciprocating motion of the head portion or the engaging-connecting portion, wherein the engaging-connecting portion of the engaging portion has a guiding portion, such that the engaging-connecting portion guidingly insertedly engages with the second object.

10. The quick-release fastener structure of claim 1, wherein the engaging-connecting portion of the engaging portion has a guiding portion whereby the engaging-connecting portion is guidedly insertedly engaged with the second object, and the guiding portion is an inclined surface portion, arced surface portion, stepwise surface portion, curved surface portion, elevated surface portion, depressed surface portion or flat surface portion.
